(19) United States
(12) Patent Application Publication
(10) Pub. No.: US 2026/0080838 A1
(43) Pub. Date: Mar. 19, 2026

(54) DRIVING METHOD FOR DRIVER OF ELECTRONIC DEVICE AND DRIVER

(71) Applicant: InnoLux Corporation, Miao-Li County (TW)

(72) Inventors: Yung-Li HUANG, Miao-Li County (TW); Wan-Jhen YAN, Miao-Li County (TW); Chan-Feng CHIU, Miao-Li County (TW)

(21) Appl. No.: 19/303,638

(22) Filed: Aug. 19, 2025

(30) Foreign Application Priority Data
Sep. 19, 2024 (CN) 202411307371.4

(51) Int. Cl. G09G 3/3291; G09G 3/20

(52) U.S. Cl. CPC G09G 3/3291; G09G 3/2074; G09G 2310/0254; G09G 2310/027; G09G 2320/0673; G09G 2340/0457

(57) ABSTRACT

A driving method for a driver of an electronic device includes steps of: receiving a plurality of frame data including a plurality of sub-pixel data, each sub-pixel data including a plurality of row sub-pixel data, wherein each row sub-pixel data corresponds to a portion of a plurality of sub-pixels corresponding to one of the plurality of scan lines; and performing calculation and comparison to determine whether one of the plurality of frame data is a critical frame data or a non-critical frame data, wherein, when P consecutive frame data is critical frame data, and P is greater than or equal to a threshold, the driver is switched from a first driving state to a second driving state, or maintained in the second driving state.

### CROSS-REFERENCE TO RELATED APPLICATIONS

This application claims the benefits of the Chinese Patent Application Serial Number 202411307371.4, filed on Sep. 19, 2024, the subject matter of which is incorporated herein by reference.

### BACKGROUND

### Field of the Application

The present application relates to a driver and a driving method for the driver and, more particularly, to a driver of an electronic device and a driving method for the driver of the electronic device, especially a driver of a display device and a driving method for the driver of the display device.

### Description of Related Art

When an electronic device has a display function to serve as a display device, and when the display device displays certain frames, horizontal crosstalk and/or vertical crosstalk may occur between sub-pixels corresponding to multiple scan lines or data lines, thereby affecting the displayed image quality. These frames are usually known as critical frames. When critical frames are displayed continuously, the load of the display device will increase. In order to reduce the aforementioned crosstalk problem, some display devices implement a pattern detection mechanism to detect whether an overloaded pattern exists. Usually, the pattern detection mechanism is executed by the timing controller (TCON) of the display device. However, when the display device is designed in the consideration of “removing the timing controller and transferring the functions of the timing controller to other chips (TCON-less)” in order to reduce costs, the display device will be unable to execute the pattern detection mechanism.

Therefore, there is a need to provide a novel driver and a driving method for the driver to alleviate and/or obviate the above problems.

### SUMMARY

The present application provides a driving method for a driver of an electronic device. The electronic device comprises a plurality of scan lines, a plurality of data lines and a plurality of sub-pixels, each of the plurality of data lines being electrically connected to a portion of the plurality of sub-pixels, each of the portion of the plurality of sub-pixels being electrically connected to one of the plurality of scan lines, the driver being electrically connected to at least a portion of the plurality of data lines. The driving method comprises the steps of: receiving a plurality of frame data, each frame data including a plurality of sub-pixel data corresponding to the portion of the plurality of sub-pixels, wherein the plurality of sub-pixel data includes a plurality of row sub-pixel data, and the row sub-pixel data corresponds to the portion of the plurality of sub-pixels corresponding to one of the plurality of scan lines; calculating an absolute difference value sequentially between the plurality of row sub-pixel data corresponding to two adjacent ones of the plurality of scan lines corresponding to one of the plurality of frame data, and defining a number of the absolute difference values greater than or equal to a first threshold as a gray scale variation corresponding to one of the two adjacent ones of the plurality of scan lines; comparing the gray scale variation corresponding to each of the plurality of scan lines with a second threshold value, and defining a number of gray scale variations greater than or equal to the second threshold value as a line number variation; and comparing the line number variation with a third threshold, and defining the one of the plurality of frame data as critical frame data when the line number variation is greater than or equal to a third threshold, wherein, when P consecutive frame data is defined as critical frame data and P is greater than or equal to a fourth threshold, the driver is switched from a first driving state to a second driving state, or the driver is maintained in the second driving state.

The present application further provides a driving method for a driver of an electronic device. The electronic device comprises a plurality of scan lines, a plurality of data lines and a plurality of sub-pixels, each of the plurality of data lines being electrically connected to a portion of the plurality of sub-pixels, each of the portion of the plurality of sub-pixels being electrically connected to one of the plurality of scan lines, the driver being electrically connected to at least a portion of the plurality of data lines. The driving method comprises the steps of: receiving a plurality of frame data, each frame data including a plurality of sub-pixel data corresponding to the portion of the plurality of sub-pixels, wherein the plurality of sub-pixel data includes a plurality of row sub-pixel data, and the row sub-pixel data corresponds to the portion of the plurality of sub-pixels corresponding to one of the plurality of scan lines; calculating an absolute difference value sequentially between the plurality of row sub-pixel data corresponding to two adjacent ones of the plurality of scan lines corresponding to one of the plurality of frame data, and defining a number of the absolute difference values greater than or equal to a first threshold as a gray scale variation corresponding to one of the two adjacent ones of the plurality of scan lines; comparing the gray scale variation corresponding to each of the plurality of scan lines with a second threshold value, and defining a number of gray scale variations greater than or equal to the second threshold value as a line number variation; and comparing the line number variation with a third threshold, and defining the one of the plurality of frame data as critical frame data when the line number variation is greater than or equal to a third threshold, wherein, when Q consecutive frame data is defined as non-critical frame data and Q is greater than or equal to a fifth threshold, the driver is switched from a second driving state to a first driving state, or the driver is maintained in the first driving state.

The present application further provides an electronic device, which comprises: a plurality of sub-pixels; a plurality of data lines, each of the plurality of data lines being electrically connected to a portion of the plurality of sub-pixels; a plurality of scan lines, wherein each of the portion of the plurality of sub-pixels is electrically connected to one of the plurality of scan lines; and a driver electrically connected to at least a portion of the plurality of data lines, wherein the driver performs driving by a driving method, and the driving method comprises the steps of: receiving a plurality of frame data, each frame data including a plurality of sub-pixel data corresponding to the portion of the plurality of sub-pixels, wherein the plurality of sub-pixel data includes a plurality of row sub-pixel data, and the row sub-pixel data corresponds to the portion of the plurality of sub-pixels corresponding to one of the plurality of scan lines; calculating an absolute difference value sequentially between the plurality of row sub-pixel data corresponding to two adjacent ones of the plurality of scan lines corresponding to one of the plurality of frame data, and defining a number of the absolute difference values greater than or equal to a first threshold as a gray scale variation corresponding to one of the two adjacent ones of the plurality of scan lines; comparing the gray scale variation corresponding to each of the plurality of scan lines with a second threshold value, and defining a number of gray scale variations greater than or equal to the second threshold value as a line number variation; and comparing the line number variation with a third threshold, and defining the one of the plurality of frame data as critical frame data when the line number variation is greater than or equal to a third threshold, wherein, when P consecutive frame data is defined as critical frame data and P is greater than or equal to a fourth threshold, the driver is switched from a first driving state to a second driving state, or the driver is maintained in the second driving state.

Other novel features of the application will become more apparent from the following detailed description when taken in conjunction with the accompanying drawings.

### BRIEF DESCRIPTION OF DRAWINGS

FIG. 1 is a schematic diagram of a display device according to an embodiment of the present application;

FIG. 2 is a schematic diagram of a portion of the operation of the detection procedure according to an embodiment of the present application;

FIG. 3 is a flowchart illustrating the steps of the driving method according to the first embodiment of the present application;

FIG. 4 is a schematic diagram of a driving method corresponding to critical frame data according to an embodiment of the present application;

FIG. 5 is a flowchart illustrating the steps of the driving method according to the second embodiment of the present application;

FIG. 6 is a schematic diagram of a driving method corresponding to critical frame data according to an embodiment of the present application; and

FIG. 7 is a schematic diagram of the second driving state of a driver according to an embodiment of the present application.

### DETAILED DESCRIPTION OF EMBODIMENT

Reference will now be made in detail to exemplary embodiments of the present application, examples of which are illustrated in the accompanying drawings. Wherever possible, the same reference numerals are used in the drawings and description to refer to the same or like parts.

Throughout the specification and the appended claims, certain terms may be used to refer to specific components. Those skilled in the art will understand that electronic device manufacturers may refer to the same components by different names. The present application does not intend to distinguish between components that have the same function but have different names. In the following description and claims, words such as “containing” and “comprising” are open-ended words, and should be interpreted as meaning “including but not limited to”.

The terms, such as “about”, “substantially” or “approximately”, are generally interpreted as within 10% of a given value or range, or as within 5%, 3%, 2%, 1% or 0.5% of a given value or range.

In the specification and claims, unless otherwise specified, ordinal numbers, such as “first” and “second”, used herein are intended to distinguish components rather than disclose explicitly or implicitly that names of the components bear the wording of the ordinal numbers. The ordinal numbers do not imply what order a component and another component are in terms of space, time or steps of a manufacturing method. Thus, what is referred to as a “first component” in the specification may be referred to as a “second component” in the claims.

In the present application, the terms “the given range is from the first value to the second value” and “the given range falls within the range from the first value to the second value” mean that the given range includes the first value, the second value, and other values between the first and second values.

In addition, the electronic device disclosed in the present application may include a display device, an exposure device, a printing device, a three-dimensional printing device, a vehicle device, an imaging device, an assembly device, a light-emitting device, an antenna device, a tiled device, a touch electronic device, a curved electronic device, or a free shape electronic device, but not limited thereto. The display device may include, for example, liquid crystal, light emitting diode, fluorescence, phosphor, other suitable display media, or a combination thereof, but not limited thereto. The display device may be a non-self-luminous display device or a self-luminous display device. The antenna device may be a liquid crystal type antenna device or a non-liquid crystal type antenna device, and the sensing device may be a sensing device that senses capacitance, light, heat energy, or ultrasound, but not limited thereto. The tiled device may include, for example, a display tiled device or an antenna tiled device, but not limited thereto. It should be noted that the electronic device may be any arrangement or combination of the aforementioned, but not limited thereto. In addition, the electronic device may be a bendable or flexible electronic device. It should be noted that the electronic device may be any arrangement or combination of the aforementioned, but not limited thereto. In addition, the shape of the electronic device may be rectangular, circular, polygonal, a shape with curved edges, or other suitable shapes. The electronic device may have a peripheral system, such as a driving system, a control system, a light source system, a shelf system, etc. to support a display device, an antenna device, or a tiled device. In addition, the electronic device may include an electronic unit, and the electronic unit may include passive components and active components, such as capacitors, resistors, inductors, electrodes, liquid crystal cells, variable capacitors, filters, light-emitting units, diodes, transistors, sensors, micro-electromechanical system (MEMS) components, liquid crystal chips, controllers, etc., but not limited to these. The diode may include a light emitting diode or a photodiode. The light emitting diode may include, for example, an organic light emitting diode (OLED), a mini LED, a micro LED, a quantum dot LED, fluorescence, phosphor or other suitable materials, or a combination thereof, but not limited thereto. The sensor may include, for example, capacitive sensors, optical sensors, electromagnetic sensors, fingerprint sensors (FPS), touch sensors, antennas, or pen sensors, but not limited thereto. The controller may include, for example, a timing controller, etc., but not limited thereto.

It is noted that the following are exemplary embodiments of the present application, but the present application is not limited thereto, while a feature of some embodiments can be applied to other embodiments through suitable modification, substitution, combination, or separation.

Unless otherwise defined, all terms (including technical and scientific terms) used herein have the same meaning as commonly understood by those skilled in the art related to the present application. It can be understood that these terms, such as those defined in commonly used dictionaries, should be interpreted as having meaning consistent with the relevant technology and the background or context of the present application, and should not be interpreted in an idealized or excessively formal way. Unless there is a special definition in the embodiment of the present application.

In addition, the term “adjacent” used herein may refer to describe mutual proximity, and two adjacent items may or may not be in contact with each other.

In addition, the description of “when” or “while” in the present application means “now, before, or after”, etc., and is not limited to occurrence at the same time. In the present application, the similar description of “disposed on” or the like refers to the corresponding positional relationship between the two elements, and does not limit whether there is contact between the two elements, unless specifically limited. Furthermore, when the present application recites multiple effects, if the word “or” is used between the effects, it means that the effects can exist independently, but it does not exclude that multiple effects can exist at the same time.

In the following description, a display device will be used as an electronic device to illustrate the content of the present application, but it is not limited thereto. The driving method of the present application may be used for a driver of a display device 1, wherein the driver may be, for example, a data driver or a scan driver, but it is not limited thereto. For the convenience of explanation, a data driver is taken as an example in the following description.

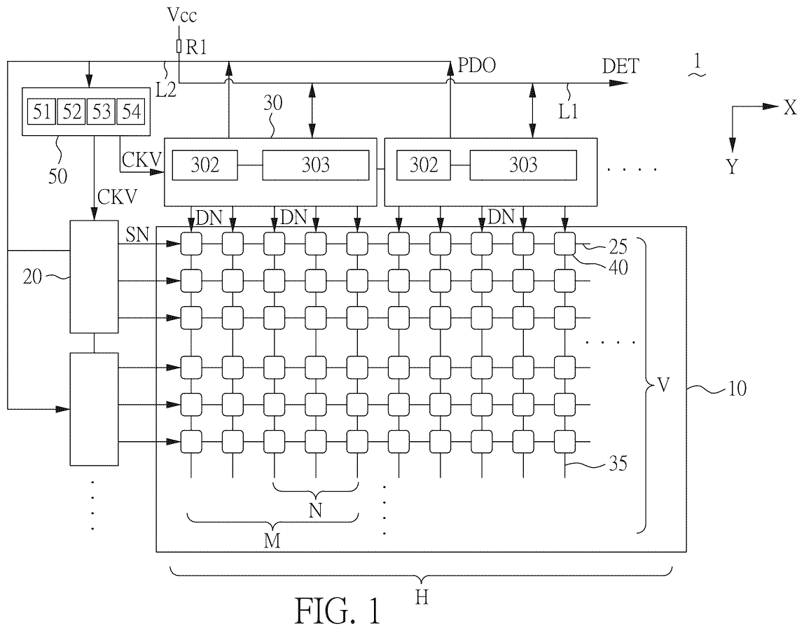

FIG. 1 is a schematic diagram of a display device 1 according to an embodiment of the present application. The display device 1 may be used to display images. As shown in FIG. 1, the display device 1 may include a substrate 10, at least one scan driver 20, at least one data driver 30, a plurality of (for example, V) scan lines 25, a plurality of (for example, H) data lines 35, and a plurality of sub-pixels 40, wherein V and H are each a positive integer greater than 1. For ease of explanation, the following will take the display device 1 having a plurality of scan drivers 20 and a plurality of data drivers 30 as an example. Each scan driver 20 may be electrically connected to one or more of the V scan lines 25. Each data driver 30 may be electrically connected to a portion of the plurality of data lines 35 (for example, M data lines 35 among the H data lines 35), where M is a positive integer and M may be smaller than or equal to H (that is, M≤H). Each data line 35 of the H data lines 35 may be electrically connected to a portion of the plurality of sub-pixels 40 (for example, V sub-pixels 40 among the plurality of sub-pixels 40), and each sub-pixel 40 of the portion of the plurality of sub-pixels 40 is electrically connected to one of the V scan lines 25, but it is not limited thereto. Each data line 35 may be electrically connected to, for example, V sub-pixels 40, but it is not limited thereto. In one embodiment, the scan lines 25, the data lines 35 and the sub-pixels 40 may be disposed on the substrate 10. In one embodiment, the scan driver 20 and the data driver 30 may be disposed on the substrate 10, but may also be disposed on other substrates, while it is not limited thereto. In one embodiment, the substrate 10 may be, for example, a glass substrate, a printed circuit board, or a flexible substrate, but it is not limited thereto.

In addition, the display device 1 may further include a timing controller 50, or the timing controller 50 may be disposed outside the display device 1, and the scan driver 20 and the data driver 30 may be electrically connected to the timing controller 50. In one embodiment, the timing controller 50 may be disposed on an SOC (System On Chip), for example, and the SOC is electrically connected to the substrate 10, but it is not limited thereto. In one embodiment, the timing controller 50 may include a timing control circuit 51, a gray scale circuit 52, a level shift circuit 53 and a gamma correction circuit 54, but it is not limited thereto. In one embodiment, the timing control circuit 51 may provide a timing control signal CKV to the scan driver 20 and/or the data driver 30, the gray scale circuit 52 may provide a gray scale reference signal to the data driver 30, the level shift circuit 53 may provide a level shift signal to the scan driver 20, and the gamma correction circuit 54 may be used to perform gamma correction on the image to be displayed by the display device 1, but it is not limited thereto. In one embodiment, the scan driver 20 may generate one or more scan signals SN according to the timing control signal CKV and the level shift signal, but it is not limited thereto. In one embodiment, the data driver 30 may generate one or more sub-pixel data DN according to the timing control signal CKV and the gray scale reference signal, but it is not limited thereto. The plurality of sub-pixel data DN may form a frame data, wherein one or more frame data may be used to enable the display device 1 to display a frame. Therefore, it may also be considered that the data driver 30 may receive the frame data from the timing controller 50, but it is not limited thereto.

In one embodiment, the display device 1 may be, for example, a backlight display device, a reflective display device, a self-luminous display device, or other types of display devices, but it is not limited thereto. In one embodiment, the resolution of the display device 1 may be defined as H×V. For example, the display device 1 may include H×V×Z sub-pixels 40, where Z may be a positive integer greater than 2, in which Z may be regarded as the number of sub-pixels in each pixel, but it is not limited thereto. In addition, a frame rate of the display device 1 may be defined as F, and its unit may be Hertz (Hz).

In one embodiment, each sub-pixel 40 may have a switch (not shown), and the scan driver 20 may transmit a scan signal SN to the sub-pixel 40 electrically connected to the scan line 25 via the scan line 25 to turn on the switch in each sub-pixel 40, so that the sub-pixel 40 may receive the sub-pixel data DN transmitted by the data line 35, wherein the switch may be, for example, a transistor, but it is not limited thereto. In one embodiment, each sub-pixel 40 may further include a liquid crystal layer (not shown), and the liquid crystal layer may include liquid crystal molecules (not shown), but it is not limited thereto.

In one embodiment, the data driver 30 may receive a plurality of frame data provided by the timing controller 50, store the frame data, and provide the frame data to the sub-pixels 40 on the corresponding scan line 25 via the data line 35 corresponding to the data driver 30. Each frame data may correspond to at least a portion of a frame to be displayed by the display device 1. For example, a frame data corresponding to a data driver 30 may be a complete frame, or may be a partial area of a complete frame, while it is not limited thereto. In one embodiment, each frame data may include a plurality of sub-pixel data DN to correspond to a portion of the plurality of sub-pixels 40. For example, each frame data may include M sub-pixel data DN, wherein the M sub-pixel data DN may include N row sub-pixel data DN stored by the data driver 30 and the remaining M-N row sub-pixel data DN, wherein N is a positive integer and M is greater than or equal to N (that is, M≥N). Therefore, each data driver 30 may transmit the M sub-pixel data DN to the sub-pixel 40 electrically connected thereto through the M data lines 35 electrically connected thereto, and each data driver 30 may also perform a detection procedure for the N row sub-pixel data DN transmitted by N data lines 35 among the stored M data lines 35 so as to determine whether the data driver 30 needs to switch the driving state, wherein the detection procedure will be described in the subsequent paragraphs.

In addition, in one embodiment, each data driver 30 may include at least one processing unit 302 and at least one temporary storage unit 303, wherein the processing unit 302 may be, for example, a processor, and the temporary storage unit 303 may be, for example, a memory or a register, but it is not limited thereto. It should be noted that the data driver 30 may further include other components, such as a driving circuit (not shown), etc., while it is not limited thereto.

Next, the details of the “detection procedure” will be described.

The features of the present application include that the data driver 30 may execute a detection procedure for the N row sub-pixel data DN to determine whether the frame data corresponding to the data driver 30 (for example, at least a portion of the actual frame) is critical frame data or non-critical frame data. In another embodiment, the timing controller 50 may execute a detection procedure to determine whether the frame data is critical frame data or non-critical frame data. Here, “critical frame data” means that the frame data may cause horizontal crosstalk and/or vertical crosstalk problems in the display device 1, so that a critical frame may be generated. Here, “non-critical frame data” means that the frame data is less likely to cause horizontal crosstalk and/or vertical crosstalk problems, but it is not limited thereto. In one embodiment, the detection procedure may be implemented by the processing unit 302 of the data driver 30 executing at least one logic operation step, wherein the logic operation step may include a plurality of logic gates to perform operations or judgments, and the processing unit 302 may execute the plurality of logic operations or judgments to implement the detection procedure.

In more detail, each data driver 30 may perform a detection procedure on the sub-pixel data DN received by at least a portion of the sub-pixels 40 electrically connected to each scan line 25, and determine whether the frame data corresponding to the current data driver 30 is critical frame data or non-critical frame data based on the detection result. In one embodiment, the detection procedure may include a gray scale variation acquisition phase, a line number variation acquisition phase, a critical frame data determination phase, and a driving state adjustment phase, while it is not limited thereto.

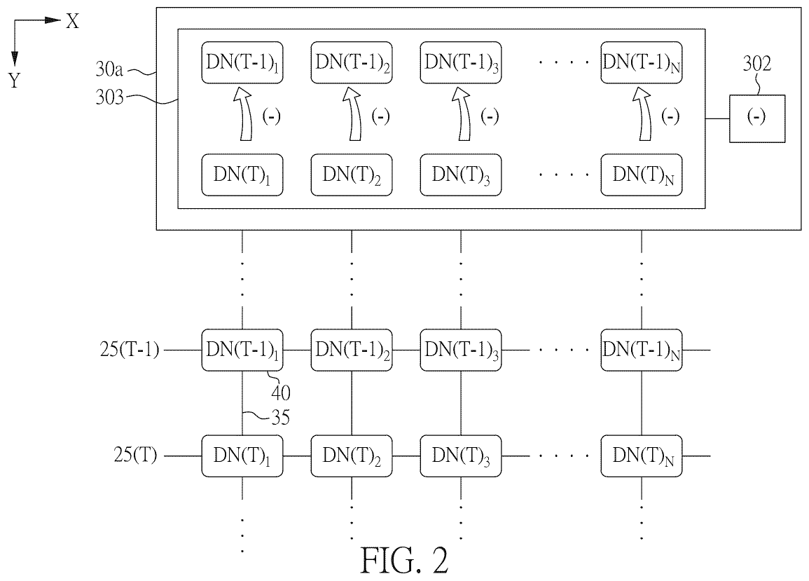

FIG. 2 is a schematic diagram of a portion of the operation of the detection procedure according to an embodiment of the present application, and please refer to FIG. 1 at the same time.

In one embodiment, when one of the data drivers 30 (hereinafter referred to as data driver 30a) performs a detection procedure for one of the scan lines 25(T), the temporary storage unit 303 in the data driver 30a may store N row sub-pixel data DN(T)₁˜DN(T)_{N} received by the N sub-pixels 40 corresponding to the scan line 25(T), and also store N portions of sub-pixel data DN(T−1)₁˜DN(T−1)_{N} received by the N sub-pixels 40 corresponding to an adjacent scan line of the scan line 25(T) (for example, but not limited to, the previous scan line 25(T−1)). It should be noted that the “front-to-back order” between the scan lines 25 may be, for example, the arrangement order of the plurality of scan lines 25 in a first direction (Y), but it is not limited thereto.

Regarding the “gray scale variation acquisition phase”, in one embodiment, the processing unit 302 of the data driver 30a may sequentially compare the N row sub-pixels data DN(T)₁˜DN(T)N received by the N sub-pixels 40 corresponding to the scan line 25(T) with the N row sub-pixel data DN(T−1)₁˜DN(T−1)N received by the N sub-pixels 40 corresponding to the adjacent previous scan line 25(T−1), so as to sequentially obtain an absolute difference value |DN(T)_{1˜N}-DN(T−1)_{1˜N}| between the row sub-pixel data DN(T)₁˜DN(T)N and DN(T−1)₁˜DN(T−1)N received by the 1-st to N-th sub-pixels 40 corresponding to the two scan lines 25(T) and 25(T−1). For example, the row sub-pixel data DN(T)₁ of the first sub-pixel 40 of the scan line 25(T) and the row sub-pixel data DN(T−1)₁ of the first sub-pixel 40 of the scan line 25(T−1) are subject to an absolute difference value calculation (that is, |DN(T)₁−DN(T−1)₁|), the row sub-pixel data DN(T)₂ of the second sub-pixel 40 of the scan line 25(T) and the row sub-pixel data DN(T−1)₂ of the second sub-pixel 40 of the scan line 25(T−1) are subject to an absolute difference value calculation (that is, |DN(T)₂−DN(T−1)₂|), and so on. Thus, for each scan line 25, the data driver 30a may obtain N absolute difference values. It should be noted that the “order” between the sub-pixels 40 may be, for example, the arrangement order of the plurality of sub-pixels 40 in a second direction (X), but it is not limited thereto.

In addition, in one embodiment, the data driver 30a may extract a portion of the data amount (defined as L) from the row sub-pixel data DN(T)₁˜N or DN(T−1)₁˜N on each data line 35 as a value for calculation, wherein the unit of the data amount L may be bits, and it is not necessary to fully extract all the data amount (for example, the complete data size is 10 bits, and the extracted data size is 8 bits), thereby reducing the calculation cost, but it is not limited thereto. In one embodiment, L may be greater than or equal to 1 bit (that is, L≥1 bit). In one embodiment, L may be between 3 bits and 10 bits (that is, 3 bits≤L≤10 bits), but it is not limited thereto.

Furthermore, in one embodiment, the data driver 30a may compare each of the obtained N absolute difference values with a first threshold TH1, then count the number of the N absolute difference values that exceed the first threshold TH1, and define the number as a gray scale variation corresponding to the scan line 25(T). For example, if 30 of the N absolute difference values exceed the first threshold TH1, the gray scale variation of the scan line 25(T) may be “30”. In one embodiment, the first threshold TH1 may be associated with the gray scale value of the sub-pixel 40 corresponding to the frame data. In one embodiment, the first threshold TH1 may be between 0.5 times 2 to the power of L and 0.9 times 2 to the power of L (that is, 0.5×2^{L}≤TH1≤0.9×2^{L}), but it is not limited thereto. By analogy, the data driver 30a may obtain the gray scale variation corresponding to each scan line 25.

Next, regarding the “line number variation acquisition phase”, in one embodiment, the data driver 30a may compare the gray scale variation corresponding to each scan line 25 with a second threshold TH2, count the number of gray scale variations of all scan lines 25 that are greater than or equal to the second threshold TH2, and define the number as a line number variation. For example, if the gray scale variation corresponding to 20 scan lines 25 among all the scan lines 25 is greater than or equal to the second threshold TH2, the line number variation of the frame data currently displayed by the display device 1 will be defined as “20”. In one embodiment, the second threshold TH2 may be between 0.5 times N and 0.9 times N (that is, 0.5×N≤TH2≤0.9×N), but it is not limited thereto. By analogy, the data driver 30a may obtain the line number variation of corresponding frame data.

Next, regarding the “critical frame data determination phase”, in one embodiment, the data driver 30a may compare the line number variation corresponding to the frame data with a third threshold value TH3. When the line number variation is greater than or equal to the third threshold value TH3, the data driver 30a will define the corresponding frame data as critical frame data. Conversely, when the line number variation is smaller than the third threshold value TH3, the data driver 30a will define the corresponding frame data as non-critical frame data. In one embodiment, the third threshold TH3 may be between 0.5 times V and 0.9 times V (that is, 0.5×V≤TH3≤0.9×V), but it is not limited thereto. By analogy, the data driver 30a may respectively define the received consecutive multiple frame data as critical frame data or non-critical frame data.

Next, regarding the “driving state adjustment phase”, in one embodiment, when the frame data corresponding to P (P is a positive integer) consecutive data drivers 30a are all defined as critical frame data, and P is greater than or equal to a fourth threshold value TH4, the data driver 30a may determine that the corresponding P consecutive frame data belong to a critical state, wherein the “critical state” means that the P frame data may cause horizontal crosstalk and/or vertical crosstalk problems. At this moment, the data driver 30a may be switched from a first driving state to a second driving state, or may be maintained in the second driving state (when the original state is the second driving state) so as to respond to the critical state. In addition, in one embodiment, when the frame data corresponding to Q consecutive data drivers 30a are defined as non-critical frame data, where Q is a positive integer and Q is greater than or equal to a fifth threshold value TH5, the processing unit 302 may determine that the corresponding Q consecutive frame data belong to a normal state, where “normal state” means that the possibility of horizontal crosstalk and/or vertical crosstalk is low. At this moment, the data driver 30a may be maintained in the first driving state (when the original state is the first driving state), or switched from the second driving state to the first driving state. In one embodiment, the fourth threshold TH4 and/or the fifth threshold TH5 may be associated with the frame rate F of the display device 1. In one embodiment, the fourth threshold TH4 may be between 0.1 times F and 1 times F (that is, 0.1×F≤TH4≤F), but it is not limited thereto. In one embodiment, the fifth threshold TH5 may be between 0.1 times F and 1 times F (that is, 0.1×F≤TH5≤F), but it is not limited thereto.

It should be noted that, by comparing a consecutive number of frame data with the fourth threshold TH4 or the fifth threshold TH5 to determine whether to switch the driving state, the switching action of the data driver 30 will not be too frequent, thereby improving the display quality.

In one embodiment, the first threshold TH1 to the fifth threshold TH5 may be preset, and the setting results may be stored in the temporary storage unit 303 or the processing unit 302, while it is not limited thereto. In one embodiment, each data driver 30 may include a plurality of temporary storage units 303, and the aforementioned row sub-pixel data DN, the first threshold TH1 to the fifth threshold TH5 or other setting parameters may be stored in the same or different temporary storage units 303, while it is not limited thereto.

In one embodiment, the “first driving state” is the initial state of the driver (for example, the data driver 30 or the scan driver 20) when the display device 1 is turned on, but it is not limited thereto. In one embodiment, the “first driving state” is a state when a driver (for example, data driver 30 or scan driver 20) operates normally, such as when the display device 1 displays a normal frame, is in standby or sleep mode, but it is not limited thereto.

In one embodiment, the “second driving state” is a state in which a driver (for example, data driver 30 or scan driver 20) performs one or more actions in response to the critical frame data. In one embodiment, “one or more corresponding actions” may include: at least one of actions one to eleven, or any combination thereof, while it is not limited thereto. The actions one to eleven are described in the following.

The action one is provided to adjust the polarity corresponding to the sub-pixels 40. For example, when the frame data needs to be adjusted (that is, when P consecutive frame data are judged to belong to critical frame data), the data driver 30 may adjust the sub-pixel data DN transmitted to the sub-pixel 40, so that the polarity of some or all of the sub-pixels 40 is switched, such as from positive polarity to negative polarity, or from negative polarity to positive polarity, or the polarity of some or all of the sub-pixels 40 originally required to be presented when corresponding to the next frame may be changed, for example, while it is not limited thereto.

The action two is provided to adjust the thrust output of the data driver 30. For example, when the frame needs to be adjusted, the data driver 30 may adjust the current value of the gray scale signal of the sub-pixel data DN transmitted to the sub-pixel 40 (the voltage value may remain unchanged, and thus the gray scale value does not change), for example, the output current value may be increased, or the output current value may be decreased, wherein the magnitude of the thrust may correspond to the time for the sub-pixel 40 to reach the desired gray scale value, while it is not limited thereto.

The action three is provided to adjust the gray scale value corresponding to sub-pixel 40. For example, when the frame needs to be adjusted, the data driver 30 may adjust the sub-pixel data DN transmitted to the sub-pixel 40, thereby adjusting the gray scale value that the sub-pixel 40 needs to display. For example, the data driver 30 may transmit a message to the timing controller 50, so that the timing controller 50 adjusts the gray scale reference signal transmitted to the data driver 30, and then the data driver 30 adjusts the sub-pixel data DN transmitted to the sub-pixel 40, while it is not limited thereto.

The action four is provided to adjust the driving voltage. For example, when the frame needs to be adjusted, the data driver 30 may adjust various driving voltages, such as adjusting a gamma correction voltage (VGMA). More specifically, the data driver 30 may transmit a message to the timing controller 50, so that the timing controller 50 adjusts the gamma correction signal transmitted to the data driver 30, thereby allowing the data driver 30 to adjust the gamma correction voltage (VGMA) transmitted to the sub-pixel 40, while it is not limited thereto.

The action five is provided to adjust the width of a high level period of a latch signal LD provided by the timing controller 50. The width of the high level period of the latch signal LD may correspond to the length of time for performing charge sharing between the plurality of data lines 35 or between the plurality of scan lines 25, or may also determine whether charge sharing is to be performed or not, while it is not limited thereto.

The action six is provided to adjust the bias voltage of the data driver 30, wherein the bias voltage is related to the charging time of the sub-pixel 40, but it is not limited thereto.

The action seven is provided to perform high impedance (Hi-Z) control, wherein the high impedance control may, for example, control whether the data driver 30 outputs a signal or not. In other words, when the high impedance control is performed, the data driver 30 will not output a signal.

The action eight is provided to adjust the frame rate F. For example, when the frame needs to be adjusted, the frame rate F may be reduced from a high frequency to a low frequency, or increased from a low frequency to a high frequency, while it is not limited thereto.

The action nine is provided to adjust the operation of the scan driver 20. For example, when the frame needs to be adjusted, the data driver 30 may transmit a control signal or may transmit a control signal through the timing controller 50 to the scan driver 20, so as to suspend the operation of the scan driver 20 or change the scan sequence of the scan driver 2 for each scan line 25, etc., but it is not limited thereto.

The action ten is provided to adjust the operation of the data driver 30. For example, when there is a need to adjust the frame, the data driver 20 may adjust the driving sequence of each data line 35 (for example, adjust the sequence of providing the sub-pixel data DN to each data line 35), while it is not limited thereto.

The action eleven is provided to adjust the scanning time of the scan lines 25. For example, when the frame needs to be adjusted, the data driver 30 may transmit a control signal or transmit a control signal through the timing controller 50 to the scan driver 20 so as to change the scanning time of the scan driver 2 for each scan line 25, etc., while it is not limited thereto.

In one embodiment, the data driver 30 may be used to execute an algorithm to determine the action to be performed in the second driving state according to the content of the sub-pixel data DN, such as at least one of actions one to eleven, or any combination of the above, while it is not limited thereto.

In addition, please refer to FIG. 1 and FIG. 2 at the same time. In some embodiments, the display device 1 includes a plurality of data drivers 30, each of which corresponds to a different group of N data lines 35. Therefore, each data driver 30 may perform a detection procedure for the row sub-pixel data DN corresponding to the different group of N data lines 35. For example, a frame displayed by the display device 1 may be divided into a plurality of areas (which may be regarded as being divided into a plurality of frame data, each of which corresponds to one of the data drivers 30). In this case, each area may be detected by a different data driver 30.

Furthermore, when different areas are detected by different data drivers 30, the data driver 30 may have different settings for the switching conditions of the driving state, as described below.

In one embodiment, the display device 1 has a setting A, wherein setting A is: when any one of a plurality of areas of the frame or at least one area is detected as being in an critical state, each data driver 30 will be switched from the first driving state to the second driving state, or maintained in the second driving state, while it is not limited thereto. In setting A, the detection procedure may be performed on not only one area or a portion of the area of the frame, but also all areas of the frame at the same time. In other words, as long as one area is detected to be in the critical state, the plurality of data drivers 30 corresponding to the plurality of areas of the entire frame will all be switched from the first driving state to the second driving state, or maintained in the second driving state.

In one embodiment, the display device 1 has a setting B, wherein the setting B is: when one of a plurality of areas of the frame is detected as being in a critical state, the data driver 30 corresponding to the one of the areas will be switched from the first driving state to the second driving state, or maintained in the second driving state, while the remaining data drivers 30 are not affected by the data driver 30, but it is not limited thereto. In setting B, the detection procedure may be performed on not only one or a portion of the area of the frame, but also all areas of the frame at the same time. In other words, each data driver 30 is only responsible for adjusting the area in the corresponding frame, and different data drivers 30 will not affect each other to change the driving states of other data drivers 30.

In one embodiment, the display device 1 may have a setting C, wherein the setting C is: when all areas are detected as being in a critical state, all data drivers 30 will be switched from the first driving state to the second driving state, or maintained in the second driving state. In setting C, all areas need to be detected at the same time, but it is limited thereto.

As shown in FIG. 1, in one embodiment, a plurality of data drivers 30 may be electrically connected to each other via a signal line L1, so that one of the data drivers 30 may transmit a detection result signal DET to other data drivers 30 via the signal line L1, thereby enabling other data drivers 30 to execute the aforementioned setting A, setting B or setting C, but it is not limited thereto. In addition, in one embodiment, each data driver 30 may be electrically connected to the timing controller 50 or the scan driver 20 through another signal line L2, and then transmit a control signal PDO to the timing controller 50 or the scan driver 20 according to the detection result of the detection procedure, so that the timing controller 50 or the scan driver 20 performs an action related to the second driving state, but it is not limited to this.

Accordingly, the detection procedure of the present application can be understood.

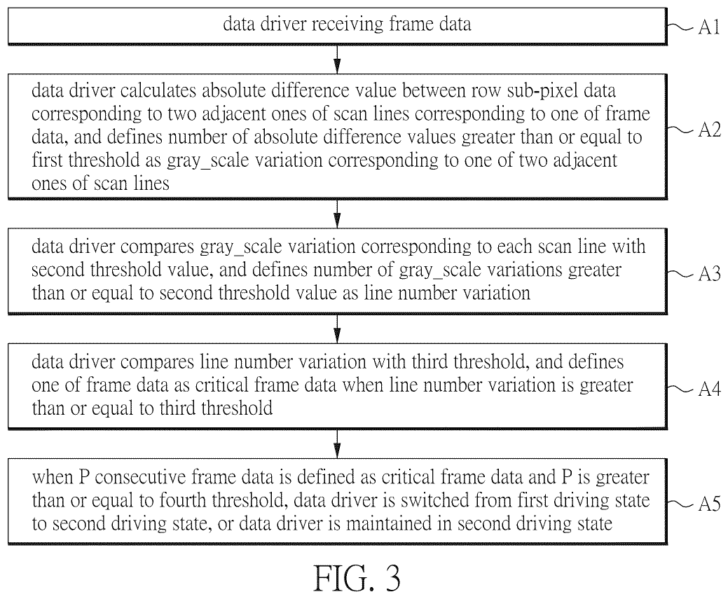

Through the detection procedures, the present application may provide a driving method for the data driver 30 of the display device 1. FIG. 3 is a flowchart illustrating the steps of the driving method according to the first embodiment of the present application, and please refer to FIG. 1 and FIG. 2. The driving method is applicable to a data driver 30. In FIG. 3, the switching condition of the driving state of the data driver 30 may be applicable to the aforementioned setting A or setting B, and may be applicable to the aforementioned setting C in specific circumstances (for example, when all areas of the frame are detected as being in a critical state). In addition, the preset state of the data driver 30 is the first driving state.

First, step A1 is executed, wherein a data driver 30 receives a plurality of frame data. Each of the plurality of frame data may correspond to at least a portion of an area of a frame displayed by the display device 1, and different frame data received by each data driver 30 may correspond to at least a portion of an area of a different frame. In addition, each frame data may include M sub-pixel data DN, wherein the M sub-pixel data DN includes N row sub-pixel data DN, and the row sub-pixel data DN corresponds to N sub-pixels 40 corresponding to one of the V scan lines 25.

Then, step A2 is executed, in which one of the data drivers 30 calculates the absolute difference value sequentially between the plurality of row sub-pixel data DN corresponding to two adjacent ones of the plurality of scan lines 25 corresponding to one of the plurality of frame data, and defines the number of absolute difference values exceeding the first threshold TH1 as the gray scale variation corresponding to one of the two adjacent ones of the plurality of scan lines 25. The implementation details of this step may be referred to the description of the gray scale variation acquisition phase of the detection procedure, and thus a detailed description is deemed unnecessary.

Then, step A3 is executed, wherein one of the data drivers 30 compares the gray scale variation corresponding to each of the plurality of scan lines 25 with the second threshold TH2, and defines the number of scan lines 25 with gray scale variation being greater than or equal to the second threshold as the line number variation. The implementation details of this step may be referred to the description of the line number variation acquisition phase in the detection procedure, and thus a detailed description is deemed unnecessary.

Then, step A4 is executed, the data driver 30 compares the line number variation of the one of the plurality of frame data with the third threshold TH3. When the line number variation is greater than or equal to the third threshold TH3, the one of the plurality of frame data is defined as the critical frame data. The details of this step may be referred to the description of the critical frame data determination phase of the detection procedure, and thus a detailed description is deemed unnecessary. By repeatedly executing steps A2 to A4, the data driver 30 may define each of the plurality of frame data as critical frame data or non-critical frame data.

Then, step A5 is executed. When P consecutive frame data are defined as critical frame data and P is greater than or equal to the fourth threshold TH4, one of the data drivers 30 is switched from the first driving state to the second driving state, or maintained in the second driving state. The implementation details of this step may be referred to the description of the driving state adjustment phase of the detection procedure, and thus a detailed description is deemed unnecessary. It should be noted that, although the above driving method is used for the data driver 30, in other embodiments, the driving method may also be applicable to a scan driver, while it is not limited thereto.

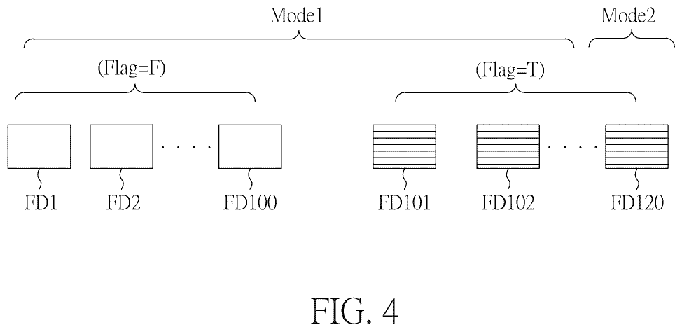

Next, the driving method of FIG. 3 is described in detail using a practical example. FIG. 4 is a schematic diagram of a driving method corresponding to critical frame data according to an embodiment of the present application, and please refer to FIG. 3 at the same time.

In this example, the resolution H×V of the display device 1 is set to 1920×1080, the frame rate F is set to 60 Hz, the first threshold TH1 is set to 128, the second threshold TH2 is set to 900, the third threshold TH3 is set to 1000, the fourth threshold TH4 is set to 20, and the fifth threshold TH5 is set to 20. Each data driver 30 is electrically connected to 960 data lines 35 (that is, M=960), and each data driver 30 performs a detection procedure on the row sub-pixel data DN corresponding to the 960 data lines 35 (that is, N=960). In addition, the data size (for example, L) captured by the data driver is set to 8 bits. In addition, the switching condition of the driving state of the data driver 30 may be applicable to the aforementioned setting A or setting B, and may be applicable to the aforementioned setting C in specific circumstances (for example, when all areas of the frame are detected as being in a critical state). The above settings are only examples but not limitation. In addition, for the convenience of explanation, FIG. 4 shows the frame data as FD.

As shown in FIG. 4, the display device 1 displays, for example, 100 consecutive frame data FD1˜FD100 that are non-critical frame data (marked with Flag=F), and then displays 20 consecutive frame data FD101˜FD120 that are critical frame data (marked with Flag=T), wherein all sub-pixel data DN in the 100 consecutive non-critical frame data FD1-FD100 belonging to the non-critical frame data is set to correspond to the same gray scale value, for example, the gray scale values are all 128 (not shown). The 20 consecutive frame data FD101˜FD120 belonging to the critical frame data are each set as follows: the row sub-pixel data DN corresponding to the sub-pixels 40 on the odd-numbered scan lines 25 corresponding to the frame data all corresponds to the same gray scale value (not shown), for example, the gray scale values are all 255, and the row sub-pixel data DN corresponding to the sub-pixels 40 on even-numbered scan lines 25 corresponding to the frame data all corresponds to another same gray scale value, for example, the gray scale values are all 0 (not shown). The gray scale values mentioned above are only examples but not limitation.

Corresponding to step A1 of FIG. 3, a data driver 30 receives the 100 normal frame data FD1˜FD100 and the 20 frame data FD101˜FD120 belonging to the critical frame data. Next, corresponding to steps A2 to A5 of FIG. 3, one of the data drivers 30 performs a detection procedure on the frame data FD1˜FD120. For the first 100 frame data, corresponding to steps A2 and A3, the gray scale values corresponding to all sub-pixels 40 on each scan line 25 are all 128, and the gray scale values corresponding to all sub-pixels 40 on the previous scan line 25 adjacent to each scan line 25 are also all 128. Therefore, the absolute difference value corresponding to each sub-pixel 40 on each scan line 25 is smaller than the first threshold TH1 (that is, 0<128). Furthermore, the gray scale variation corresponding to each scan line 25 is also 0 and is smaller than the second threshold TH2 (that is, 0<900). Furthermore, corresponding to steps A3 and A4, the line number variation corresponding to each frame data is 0 and is smaller than the third threshold TH3 (that is, 0<1000). Furthermore, corresponding to steps A4 and A5, one of the data drivers 30 may define the first 100 frame data as non-critical frame data, so that one of the data drivers 30 is not switched to the second driving state, but is maintained in the original driving state (for example, the first driving state, labeled as Mode 1).

Next, for the 20 frame data belonging to the critical frame data, corresponding to steps A2 and A3, the absolute difference values between the gray scale values corresponding to the 960 sub-pixels 40 on each scan line 25 and the gray scale values corresponding to the 960 sub-pixels 40 on the adjacent previous scan line 25 are all 255, which exceeds the first threshold TH1 (that is, 255>128). Furthermore, corresponding to steps A3 and A4, the gray scale variation corresponding to each scan line 25 is 960, thus exceeding the second threshold TH2 (that is, 960>900). Since each frame data corresponds to 1080 scan lines 25, and thus the line number variation of corresponding to each frame data is 1080, which exceeds the third threshold TH3 (that is, 1080>1000). Furthermore, corresponding to steps A4 and A5, each frame data is defined as critical frame data. It should be noted that, when one of the data drivers 30 detects the first 19 frame data FD101˜FD119 among the 20 critical frame data, since the number P of consecutive critical frame data has not exceeded the fourth threshold TH4 (that is, 19≤P<20), one of the data drivers 30 will not switch the driving state, but is maintained in the original driving state (for example, the first driving state). When the data driver 30 detects the 20-th frame data FD120, since the number P of consecutive critical frame data has reached the fourth threshold TH4 (that is, P=20), the data driver 30 is switched to the second driving state (labeled as Mode 2).

Accordingly, the driving method of the first embodiment can be understood.

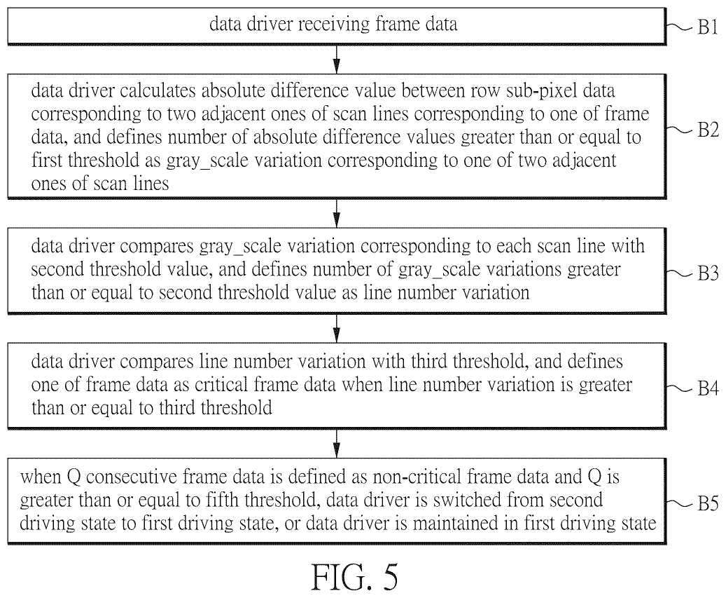

FIG. 5 is a flowchart illustrating the steps of the driving method according to the second embodiment of the present application, and please refer to FIG. 1 to FIG. 2. In FIG. 5, the switching condition of the driving state of the data driver 30 may be applicable to the aforementioned setting B or setting C, and may be applicable to the aforementioned setting A in specific circumstances (for example, when all areas of the frame are detected as being in a critical state, or when all areas of the frame are detected as being in a non-critical state).

As shown in FIG. 5, first, steps B1˜B3 are executed, wherein steps B1˜B3 may be applicable to the description of steps A1˜A3 of the first embodiment, and thus a detailed description is deemed unnecessary.

Then, step B4 is executed, the data driver 30 compares the line number variation of the one of the plurality of frame data with the third threshold TH3. When the line number variation is smaller than the third threshold TH3, the one of the plurality of frame data is defined as non-critical frame data. For details of this step, please refer to the description of the critical frame data determination phase of the detection procedure.

Then, step B5 is executed. When Q consecutive frame data are defined as non-critical frame data by one of the data drivers 30, and Q is greater than or equal to the fifth threshold TH5, the data driver 30 is switched from the second driving state to the first driving state, or the data driver 30 is maintained in the first driving state (for example, when the original driving state is the first driving state). For details of this step, please refer to the description of the driving state adjustment phase of the detection procedure.

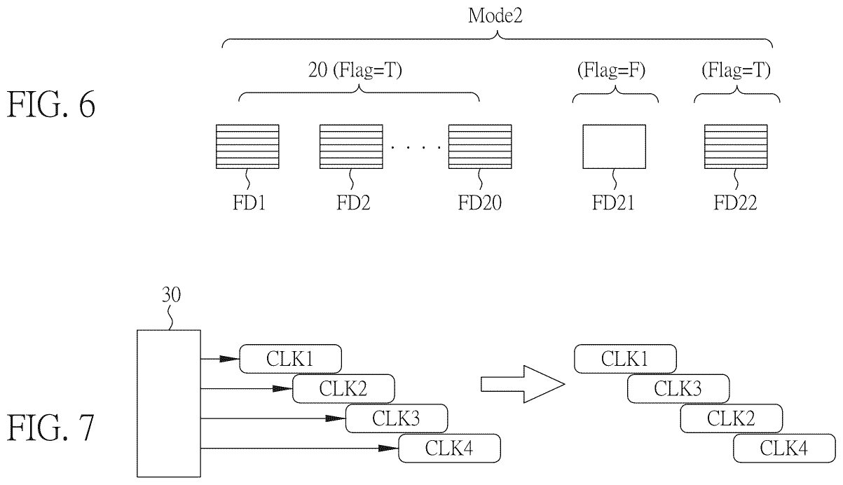

Next, the driving method of FIG. 5 is described in more detail using an example. FIG. 6 is a schematic diagram of a driving method corresponding to critical frame data according to an embodiment of the present application, and please refer to FIG. 5 at the same time.

In FIG. 6, the resolution H×V of the display device 1 is set to 1920×1080, the frame rate F is set to 60 Hz, the first threshold TH1 is set to 128, the second threshold TH2 is set to 450, the third threshold TH3 is set to 1000, the fourth threshold TH4 is set to 20, and the fifth threshold TH5 is set to 20. Each data driver 30 is electrically connected to 960 data lines 35 (that is, M=960), and each data driver 30 performs a detection procedure on the row sub-pixel data DN corresponding to 480 data lines 35 among the 960 data lines 35 (that is, N=480). In addition, L is set to 8 bits, thereby reducing the required computing resources. In addition, the switching condition of the driving state of the data driver 30 is set to the aforementioned setting B or setting C, and may be applicable to the aforementioned setting A under specific circumstances (for example, when all areas of the frame are detected as being in a critical state, or when all areas of the frame are detected as being in a non-critical state). The above settings are only examples but not limitation.

As shown in FIG. 6, the display device 1 displays, for example, 20 consecutive frame data belonging to critical frame data (marked with Flag=T), then displays one normal frame data (marked with Flag=F), and displays another frame data belonging to critical frame data (marked with Flag=T), wherein each of the frame data belonging to the critical frame data is set as follows: the row sub-pixel data DN corresponding to the sub-pixels 40 on the odd-numbered scan lines 25 corresponding to the frame data all corresponds to the same gray scale value, for example, the gray scale values are all 255 (not shown), and the row sub-pixel data DN corresponding to the sub-pixels 40 on the even-numbered scan lines 25 corresponding to the frame data all corresponds to another same gray scale value, for example, the gray scale values are all 0 (not shown), and all the sub-pixel data DN in the normal frame data all corresponds to the same gray scale value, for example, the gray scale values are all 128 (not shown). The above values are only examples but not limitation.

Therefore, corresponding to step B1 of FIG. 5, the data driver 30 first receives the 20 frame data belonging to the critical frame data, then receives the 1 normal frame data, and receives the 1 frame data belonging to the critical frame data. Next, corresponding to steps B2˜B5 of FIG. 5, the data driver 30 performs a detection procedure on the frame data. For the first 20 frame data belonging to critical frame data, the absolute difference values between the gray scale values corresponding to the 480 sub-pixels 40 on each scan line 25 and the gray scale values corresponding to the 480 sub-pixels 40 on the adjacent previous scan line 25 are all 255, thus exceeding the first threshold value TH1 (that is, 255>128). Furthermore, the gray scale variation corresponding to each scan line 25 is 480, which exceeds the second threshold TH2 (that is, 480>450). Furthermore, the line number variation corresponding to each frame data is 1080, thus exceeding the third threshold TH3 (that is, 1080>1000). Furthermore, each frame data is determined to be critical frame data. For the 20-th frame data, since the number P of consecutive critical frame data has reached the fourth threshold TH4 (that is, P=20), the data driver 30 is switched to the second driving state (labeled as Mode 2) or maintained in the second driving state (when it is originally in the second driving state).

Next, for the 21-st frame data (that is, the 1-st normal frame data), the gray scale values corresponding to all the sub-pixels 40 on each scan line 25 are 128, and the gray scale values corresponding to all the sub-pixels 40 on the adjacent previous scan line 25 are also 128, so that the absolute difference value corresponding to each sub-pixel 40 on each scan line 25 is smaller than the first threshold TH1 (that is, 0<128). Furthermore, the gray scale variation corresponding to each scan line 25 is also 0 and is smaller than the second threshold TH2 (that is, 0<450). Furthermore, the line number variation corresponding to the 21-st frame data is 0, and is smaller than the third threshold TH3 (that is, 0<1000). Furthermore, the data driver 30 determines that the 21-st frame data is non-critical frame data. However, since the number Q of consecutive non-critical frame data has not reached the fifth threshold TH5 (that is, 1=Q<20), the data driver 30 is not switched to the first driving state and thus is maintained in the second driving state.

Next, for the 22-nd frame data (that is, the frame data belonging to the critical frame data), the absolute difference values between the gray scale values corresponding to the 480 sub-pixels 40 on each scan line 25 and the gray scale values corresponding to the 480 sub-pixels 40 on the adjacent previous scan line 25 are all 255, which exceeds the first threshold TH1 (that is, 255>128). Furthermore, the gray scale variation corresponding to each scan line 25 is 480, which exceeds the second threshold TH2 (that is, 480>450). Furthermore, the line number variation corresponding to the 22-nd frame data is 1080, which exceeds the third threshold TH3 (that is, 1080>1000). Furthermore, the 22-nd frame data is determined to be critical frame data. Since the number P of consecutive critical frame data has not exceeded the fourth threshold TH4 (that is, 1=P<20), the data driver 30 does not switch the driving state. However, since the data driver 30 is originally in the second driving state, the data driver 30 is maintained in the second driving state.

It should be noted that, in one embodiment, the driving methods of FIG. 3 and FIG. 5 may be integrated together. For example, the preset driving state is the first driving state, and then the data driver 30 will be switched from the first driving state to the second driving state only when the condition of P consecutive frame data being critical frame data is met. After the data driver 30 is switched to the second driving state, the condition of Q consecutive frame data being non-critical frame data must be met before the data driver 30 is switched from the second driving state back to the first driving state, while it is not limited thereto. As a result, the switching frequency may be prevented from being too high.

Accordingly, the driving method of the second embodiment can be understood.

Next, a more detailed description is given for some of the actions performed in the second driving state (for example, actions nine to eleven). FIG. 7 is a schematic diagram of the second driving state of a driver according to an embodiment of the present application, which is used to illustrate the state of action nine of the second driving state, and please refer to FIG. 1 to FIG. 6 at the same time.

As shown in FIG. 7, when the data driver 30 is in the first driving state, the scan driver 20 may sequentially output a first timing signal CLK1, a second timing signal CLK2, a third timing signal CLK3 and a fourth timing signal CLK4, wherein the first timing signal CLK1 to the fourth timing signal CLK4 respectively correspond to the first group of scan lines to the fourth group of scan lines (not shown), wherein each group of scan lines may include at least one scan line, so that the first group of scan lines to the fourth group of scan lines start scanning at different time points in sequence. When the data driver 30 determines that the frame needs to be adjusted, the data driver 30 may transmit a control signal to the scan driver 20 (or the data driver 30 may also transmit a control signal to the timing controller 50, and then adjust the scan driver 20 through the timing controller 50), so that the scan driver 20 sequentially outputs the first timing signal CLK1, the third timing signal CLK3, the second timing signal CLK2 and the fourth timing signal CLK4. Therefore, the first group of scan lines starts scanning first, then the third group of scan lines starts scanning, then the second group of scan lines starts scanning, and then the fourth group of scan lines starts scanning. The above contents are merely examples and the present application is not limited thereto.

In addition, in some embodiments, the second driving state may include a combination of multiple actions. For example, when action nine is executed, the scanning order between the scan lines 25 may change. At this moment, action ten may also be executed, so that the data driver 30 may adjust the transmission order of sub-pixel data to respond to action nine, but it is not limited thereto. In more detail, assuming that the scan lines 25 have a first scan line, a second scan line, a third scan line and a fourth scan line, and have a scanning order in sequence, and the frame data includes a dark frame data and a bright frame data, wherein the first scan line is preset to correspond to receiving the dark frame data, the second scan line is preset to correspond to receiving the bright frame data, the third scan line is preset to correspond to receiving the dark frame data, and the fourth scan line is preset to correspond to receiving the bright frame data, the transmission order of the sub-pixel data of the data driver 30 may be to first transmit the dark frame data, then transmit the bright frame data, then transmit the dark frame data, then transmit the dark frame data, and then transmit the bright frame data. Then, when action nine is executed, the scanning order of the scan lines is changed to the scanning order of the first scan line and the fourth scan line being unchanged and the scanning order of the second scan line and the third scan line is swapped, and thus the transmission order of the sub-pixel data of the data driver 30 may be adjusted to first transmit the dark frame data, then transmit the dark frame data, then transmit the bright frame data, and then transmit the bright frame data. The above contents are only examples but not limitation.

In addition, in one embodiment, when action nine and action ten are executed at the same time, if the charging state of the capacitor in the sub-pixel 40 has not reached saturation, the brightness of the frame data displayed by the sub-pixels 40 on the scan line 25 may be inconsistent. For example, when a sub-pixel 40 on a certain scan line 25 displays bright frame data or dark frame data corresponding to the current frame data and the previous frame data, the current display and the previous display of the sub-pixel 40 are less likely to have a brightness inconsistency problem. However, assuming that the sub-pixel 40 displays frame data of different brightness corresponding to the current frame data and the previous frame data, for example, the sub-pixel 40 displayed dark frame data last time and displays bright frame data this time, the current display of the sub-pixel 40 may be affected by the previous display, resulting in insufficient brightness. Alternatively, if the sub-pixel 40 displayed bright frame data last time and displays dark frame data this time, the current display of the sub-pixel 40 may be affected by the brightness of the previous display, resulting in excessive brightness. In order to alleviate the above problem, other actions may be performed in combination with action nine and action ten, as described below.

In one embodiment, when the data driver 30 performs action nine and action ten, it may also perform action two to adjust the thrust of the data driver 30 at the same time. When the previous frame data is bright frame data and the next frame data is dark frame data, the thrust of the data driver 30 may be increased. Alternatively, when the previous frame data is dark frame data and the next frame data is bright frame data, the thrust of the data driver 30 may be increased. Alternatively, when the previous frame data and the next frame data are frames of the same brightness (for example, both are bright frame data or both are dark frame data), the thrust of the data driver 30 may not be adjusted. However, the present application is not limited thereto.

In another embodiment, action eleven may be performed in combination with action nine and action ten to simultaneously adjust the scanning time of each scan line 25 for example, adjust the charging time of the capacitor of each sub-pixel 40). For the same scan line 25, when the previous frame data received is bright frame data and the next frame data received is dark frame data, the data driver 20 may directly or indirectly control the scan driver 30 to extend the scanning time of each scan line 25. Alternatively, when the previous frame data is dark frame data and the next frame data is bright frame data, the data driver 20 may directly or indirectly control the scan driver 30 to extend the scanning time of each scan line 25. Alternatively, when the previous frame data and the next frame data are frame data of the same brightness (for example, both are bright frame data or both are dark frame data), the scanning time of each scan line 25 is shortened or not adjusted. However, the present application is not limited thereto.

The combination of the various actions in the second driving state of the present application is not limited to this. As a result, the details of the action of the second driving state can be understood.

In one embodiment, the present application may determine whether a product in contention falls within the protection scope of the present application at least by the presence or absence of components, component configurations, mechanism observation and/or operating modes of the product, while it is not limited thereto.

The details or features of the various embodiments of the present application may be mixed and matched as long as they do not violate the spirit of the application or conflict with each other.

By means of the data driver or driving method of the present application, the present application may utilize the data driver to solve the crosstalk problem, thereby making up for the deficiencies of the prior art.

The aforementioned specific embodiments should be construed as merely illustrative, and not limiting the rest of the present application in any way.

1. A driving method for a driver of an electronic device, the electronic device comprising a plurality of scan lines, a plurality of data lines and a plurality of sub-pixels, each of the plurality of data lines being electrically connected to a portion of the plurality of sub-pixels, each of the portion of the plurality of sub-pixels being electrically connected to one of the plurality of scan lines, the driver being electrically connected to at least a portion of the plurality of data lines, the driving method comprising the steps of:
receiving a plurality of frame data, each frame data including a plurality of sub-pixel data corresponding to the portion of the plurality of sub-pixels, wherein the plurality of sub-pixel data includes a plurality of row sub-pixel data, and the row sub-pixel data corresponds to the portion of the plurality of sub-pixels corresponding to one of the plurality of scan lines;
calculating an absolute difference value sequentially between the plurality of row sub-pixel data corresponding to two adjacent ones of the plurality of scan lines corresponding to one of the plurality of frame data, and defining a number of the absolute difference values greater than or equal to a first threshold as a gray scale variation corresponding to one of the two adjacent ones of the plurality of scan lines;
comparing the gray scale variation corresponding to each of the plurality of scan lines with a second threshold value, and defining a number of gray scale variations greater than or equal to the second threshold value as a line number variation; and
comparing the line number variation with a third threshold, and defining the one of the plurality of frame data as critical frame data when the line number variation is greater than or equal to a third threshold,
wherein, when P consecutive frame data is defined as critical frame data and P is greater than or equal to a fourth threshold, the driver is switched from a first driving state to a second driving state, or the driver is maintained in the second driving state.

2. The driving method as claimed in claim 1, wherein the first driving state is an initial state of the driver when the electronic device is turned on.

3. The driving method as claimed in claim 1, wherein the second driving state is a state in which the driver is used to perform one or more actions.

4. The driving method as claimed in claim 1, wherein the driver is a data driver.

5. The driving method as claimed in claim 1, wherein a number of the plurality of sub-pixel data is greater than or equal to a number of the plurality of row sub-pixel data.

6. The electronic device as claimed in claim 4, further comprising a scan driver electrically connected to at least a portion of the plurality of scan lines.

7. The electronic device as claimed in claim 6, further comprising a timing controller electrically connected to the scan driver and the data driver.

8. The driving method as claimed in claim 7, wherein, in the second driving state, the driver performs one or more actions including: adjusting polarities corresponding to the sub-pixels, adjusting thrust output by the data driver, adjusting gray scale values corresponding to the sub-pixels, adjusting driving voltage, adjusting a width of a high level period of a latch signal provided by the timing controller, adjusting bias of the data driver, performing high impedance control, adjusting frame rate, adjusting the operation of the scan driver, and adjusting scanning time of the scan lines.

9. A driving method for a driver of an electronic device, the electronic device comprising a plurality of scan lines, a plurality of data lines and a plurality of sub-pixels, each of the plurality of data lines being electrically connected to a portion of the plurality of sub-pixels, each of the portion of the plurality of sub-pixels being electrically connected to one of the plurality of scan lines, the driver being electrically connected to at least a portion of the plurality of data lines, the driving method comprising the steps of:
receiving a plurality of frame data, each frame data including a plurality of sub-pixel data corresponding to the portion of the plurality of sub-pixels, wherein the plurality of sub-pixel data includes a plurality of row sub-pixel data, and the row sub-pixel data corresponds to the portion of the plurality of sub-pixels corresponding to one of the plurality of scan lines;
calculating an absolute difference value sequentially between the plurality of row sub-pixel data corresponding to two adjacent ones of the plurality of scan lines corresponding to one of the plurality of frame data, and defining a number of the absolute difference values greater than or equal to a first threshold as a gray scale variation corresponding to one of the two adjacent ones of the plurality of scan lines;
comparing the gray scale variation corresponding to each of the plurality of scan lines with a second threshold value, and defining a number of gray scale variations greater than or equal to the second threshold value as a line number variation; and
comparing the line number variation with a third threshold, and defining the one of the plurality of frame data as critical frame data when the line number variation is greater than or equal to a third threshold,
wherein, when Q consecutive frame data is defined as non-critical frame data and Q is greater than or equal to a fifth threshold, the driver is switched from a second driving state to a first driving state, or the driver is maintained in the first driving state.

10. The driving method as claimed in claim 9, wherein the first driving state is an initial state of the driver when the electronic device is turned on.

11. The driving method as claimed in claim 9, wherein the second driving state is a state in which the driver is used to perform one or more actions.

12. The driving method as claimed in claim 9, wherein the driver is a data driver.

13. The electronic device as claimed in claim 12, further comprising a scan driver electrically connected to at least a portion of the plurality of scan lines.

14. The electronic device as claimed in claim 13, further comprising a timing controller electrically connected to the scan driver and the data driver.

15. The driving method as claimed in claim 14, wherein, in the second driving state, the driver performs one or more actions including: adjusting polarities corresponding to the sub-pixels, adjusting thrust output by the data driver, adjusting gray scale values corresponding to the sub-pixels, adjusting driving voltage, adjusting a width of a high level period of a latch signal provided by the timing controller, adjusting bias of the data driver, performing high impedance control, adjusting frame rate, adjusting the operation of the scan driver, and adjusting scanning time of the scan lines.

16. An electronic device, comprising:
a plurality of sub-pixels;
a plurality of data lines, each of the plurality of data lines being electrically connected to a portion of the plurality of sub-pixels;
a plurality of scan lines, wherein each of the portion of the plurality of sub-pixels is electrically connected to one of the plurality of scan lines; and
a driver electrically connected to at least a portion of the plurality of data lines,
wherein the driver performs driving by a driving method, and the driving method comprises the steps of:
receiving a plurality of frame data, each frame data including a plurality of sub-pixel data corresponding to the portion of the plurality of sub-pixels, wherein the plurality of sub-pixel data includes a plurality of row sub-pixel data, and the row sub-pixel data corresponds to the portion of the plurality of sub-pixels corresponding to one of the plurality of scan lines;
calculating an absolute difference value sequentially between the plurality of row sub-pixel data corresponding to two adjacent ones of the plurality of scan lines corresponding to one of the plurality of frame data, and defining a number of the absolute difference values greater than or equal to a first threshold as a gray scale variation corresponding to one of the two adjacent ones of the plurality of scan lines;
comparing the gray scale variation corresponding to each of the plurality of scan lines with a second threshold value, and defining a number of gray scale variations greater than or equal to the second threshold value as a line number variation; and
comparing the line number variation with a third threshold, and defining the one of the plurality of frame data as critical frame data when the line number variation is greater than or equal to a third threshold,
wherein, when P consecutive frame data is defined as critical frame data and P is greater than or equal to a fourth threshold, the driver is switched from a first driving state to a second driving state, or the driver is maintained in the second driving state.

17. The electronic device as claimed in claim 16, wherein the driver is a data driver.

18. The electronic device as claimed in claim 17, further comprising a scan driver electrically connected to at least a portion of the plurality of scan lines.

19. The electronic device as claimed in claim 18, further comprising a timing controller electrically connected to the scan driver and the data driver.

20. The driving method as claimed in claim 19, wherein, in the second driving state, the driver performs one or more actions including: adjusting polarities corresponding to the sub-pixels, adjusting thrust output by the data driver, adjusting gray scale values corresponding to the sub-pixels, adjusting driving voltage, adjusting a width of a high level period of a latch signal provided by the timing controller, adjusting bias of the data driver, performing high impedance control, adjusting frame rate, adjusting the operation of the scan driver, and adjusting scanning time of the scan lines.
